(19) United States
(12) Patent Application Publication
(10) Pub. No.: US 2020/0341433 A1
(43) Pub. Date: Oct. 29, 2020

(54) Resolving Exceptions in Automatic Operations Through Machine Learning

(71) Applicant: Siemens Postal, Parcel & Airport Logistics LLC, DFW Airport, TX (US)

(72) Inventor: Michael D. Carpenter, Arlington, TX (US)

(21) Appl. No.: 16/394,144

(22) Filed: Apr. 25, 2019

(51) Int. Cl. G05B 13/02; G06N 5/02; G06N 3/08; B65G 67/24

(52) U.S. Cl. CPC G05B 13/029; B65G 67/24; G06N 3/08; G06N 5/022

(57) ABSTRACT

An automated unloader system and method. A process performed by an automatic unloader system includes performing an automatic unloading operation of parcels from a container. The process includes monitoring the automatic unloading operation using a plurality of sensors. The process includes automatically detecting an exception based on current sensor data and a knowledge base storing past sensor data. The process includes automatically resolving the exception using the knowledgebase and using resolution knowledge generated from a previous manual resolution by an operator of a corresponding type of exception.

### TECHNICAL FIELD

The present disclosure is directed, in general, to mail and parcel processing techniques.

### BACKGROUND OF THE DISCLOSURE

Automated unloader systems are valuable in industry, such as those described in U.S. Pat. Nos. 9,738,466, 9,321,601, and 8,651,794, each of which is hereby incorporated by reference. Improved and more efficient systems for unloading items from a container or trailer are desirable.

### SUMMARY OF THE DISCLOSURE

Various disclosed embodiments include a method performed by an automatic unloader system. The method includes performing an automatic unloading operation of parcels from a container. The method includes monitoring the automatic unloading operation using a plurality of sensors. The method includes automatically detecting an exception based on current sensor data and a knowledgebase storing past sensor data. The method includes automatically resolving the exception using the knowledgebase and using resolution knowledge generated from a previous manual resolution by an operator of a corresponding type of exception.

Another disclosed embodiment includes an automatic unloader system having at least one automatic unloader and a control system. The control system is configured to control the automatic unloader system to perform an automatic unloading operation of parcels from a container using the automatic unloader. The control system is configured to control the automatic unloader system to monitor the automatic unloading operation using a plurality of sensors. The control system is configured to control the automatic unloader system to automatically detect an exception based on current sensor data and a knowledgebase storing past sensor data. The control system is configured to control the automatic unloader system to automatically resolve the exception using the knowledgebase and using resolution knowledge generated from a previous manual resolution by an operator of a corresponding type of exception.

Various embodiments also include storing sensor data from the plurality of sensors in a knowledgebase. Various embodiments also include, prior to automatically detecting an exception, receiving an indication of an exception in the automatic unloading operation, receiving a user input to resolve the exception and storing the user input in the knowledgebase, and resolving the exception according to the user input, including producing commands according to the user input to resolve the exception and storing the commands in the knowledgebase as the resolution knowledge. In various embodiments, the plurality of sensors includes one or more of a parcel sensor, a position sensor, a video camera, a profile sensor, a torque sensor, and a speed sensor. In various embodiments, the knowledgebase includes a machine learning neural network. In various embodiments, the knowledgebase stores sensor data, control data, user inputs, device commands, exception indicators, exception recognition data, and exception resolution data. In various embodiments, the automatic unloader system predicts exceptions based on the sensor data and the knowledgebase. In various embodiments, the automatic unloader system learns operating conditions that define an exception type. In various embodiments, the automatic unloader system includes a plurality of automatic unloaders controlled by a same control system and a same operator station.

Other embodiments include an automatic unloader system configured to perform processes as disclosed herein and a tangible machine-readable medium storing executable instructions that, when executed, cause a control system of an automatic unloader system to perform processes as disclosed herein.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example of an operator at an operator station in accordance with disclosed embodiments;

FIG. 2 depicts a schematic view of an automatic unloader in accordance with disclosed embodiments;

FIG. 3 depicts an automated unloader system in accordance with disclosed embodiments;

FIG. 4 illustrates some sensor and control elements of an automatic unloader system 400 in accordance with disclosed embodiments;

FIG. 5 illustrates a flowchart of a process in accordance with disclosed embodiments; and

FIG. 6 depicts a block diagram of a data processing system in which an embodiment can be implemented.

### DETAILED DESCRIPTION

The figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In an effort to increase load density and reduce transportation cost, the trucking industry may use a practice called “bed-loading”. A trailer may be loaded with items of a broad range of sizes, weights, and shapes. Sacks and items having extreme aspect ratios or weights are typically bed-loaded last in a separate area of the trailer or box bed. On a full trailer, such extreme pieces may be located near the trailer door and would be the first items unloaded.

Manually unloading a bed-loaded trailer can be a grueling job that may be performed at extreme temperatures with relatively low pay. A person unloading standard packages with the aid of an extendible conveyor may achieve sustained rates in the range of 1,000 pieces per hour (1K PPH). Sacks and items of irregular size/shape are typically unloaded at rates much less than standard packages. Such reduced rates are often 200-500 PPH, depending on weight, shape, door configuration, and other factors. The time required to load or unload a trailer directly affects dock door utilization/productivity and therefore facility size. Problems have arisen with previous attempts to automate trailer unloading, including solution cost, cube loss, trailer fleet modification, throughput, staffing, package size/type/formats, loading constraints/configuration, package damage, ease of operation/automation, cost to maintain and ease of retrofitting existing loading dock facilities.

Automated unloader systems enable unloading items from a trailer or other container generally without operator intervention. For example, in some systems, a nose ramp of an automated unloading apparatus is moved under a base belt in the trailer and under a first item of a plurality of items in the trailer. As the ramp continues advancing, the item is moved onto a conveyor, which is adapted to carry the item out of the trailer. A stack control curtain maintains the remaining items in a stack or pile during and after removal of the first item. A tensioning mechanism maintains a desired tension on the base belt as the ramp moves under the base belt and the first item.

In one example of such an automated unloader system, an operator must “drive” the unloader into the container being unloaded, controlling the direction and rate movement of the automated unloader system based on responses to video feed captured by the system and displayed to the operator on a console at an operating station.

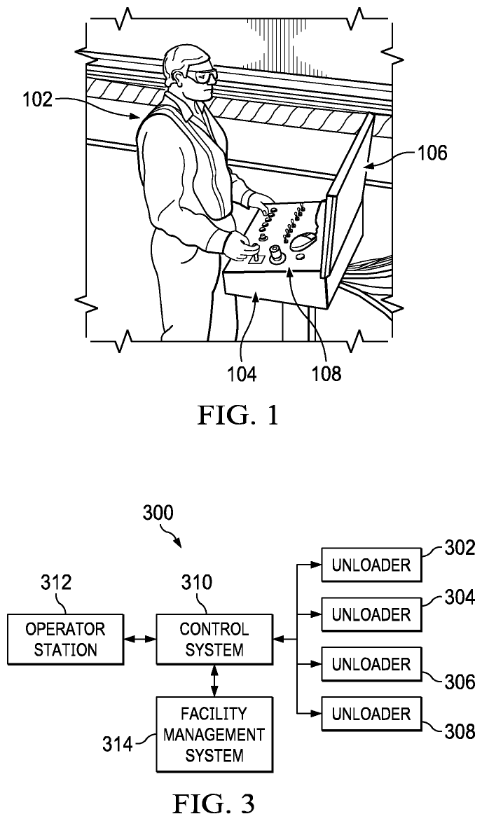

FIG. 1 illustrates an example of an operator 102 at an operator station 104 (which may also be referred to herein as a “kiosk.”). An operator station 104 is typically configured to control an individual automated unloader system, with a one-to-one relationship maintained between the operator and the automated unloader system. As shown in the example of FIG. 1, the operator station 104 can include a display 106 and a set of controls 108; the controls and display contents in accordance with disclosed embodiments are described in more detail below. A typical operator station 104 provides simple, direct controls for the operator 102 to perform manual on/off and steering tasks.

In an automated unloader system, the cycle of operation results in a duty cycle between productive unloading and other, non-productive activities of as little as 33% (depending on the speed with which the non-productive activities are carried out). Non-productive tasks include waiting for a trailer to be ready to unload, dock alignment, joining the belt. When a one-to-one relationship is maintained between the automated unloader system and the operator, this duty cycle represents a significant limitation on productivity of the operator.

There is significant difference in skills requirements between highly technical, difficult “driving” by the operator and instances in which the operator is simply monitoring the system or holding down a button, requiring little technical difficulty is another issue. The key role of an operator, then, is dealing with intervals of technically difficult actions that occur between intervals in which operation is almost automatic.

An automated unloader system can operate in a mixed automatic and manual operating mode, by which it operates automatically, without interaction or intervention, until an exception is detected. One example of such an exception is the automatic unloader ceases forward motion and the flow of unloaded parcels stops. During these exceptions, a human operator takes over and resolves the exception through sophisticated techniques, such as analyzing the state of the machine and its sensors to determine the nature of the exception, retracting actuators, or retracting and advancing the automatic unloader itself. These various operations tend to be sophisticated, and they depend on the experience and skill of the operator.

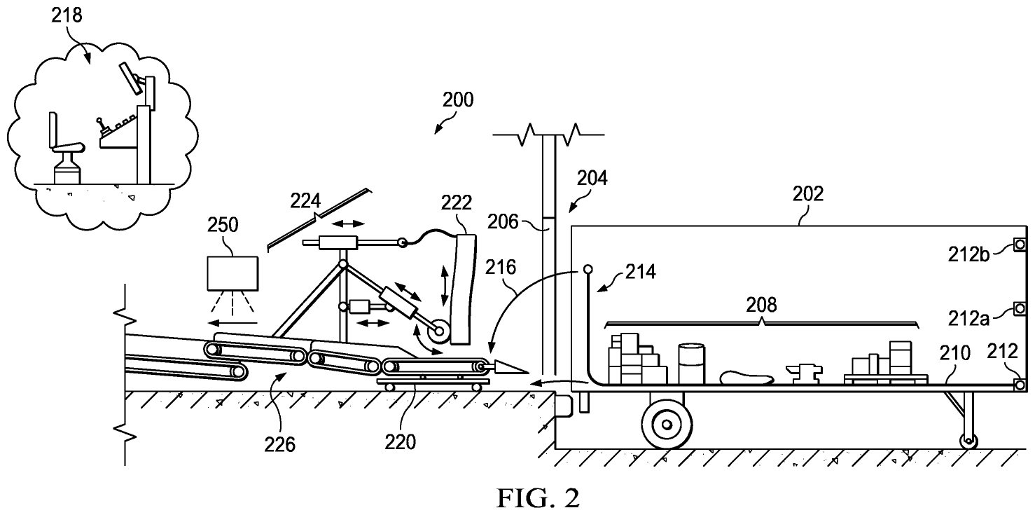

FIG. 2 depicts a schematic view of an automatic unloader 200 according to the present disclosure. A trailer (or other container) 202 is positioned adjacent to a loading dock 204 and a dock door area 206 for unloading. Within the trailer 202 are loaded items/parcels 208, which are to be unloaded by the automatic unloader 200. The items 208 are positioned on top of a base belt 210, a first end of which is attached to the trailer at an attachment point 212. A second end of the base belt 210 (opposite to the first end) may be raised to a first transit position 214 to provide supported to stacked items during transit to help prevent stack collapse. The second end of the base belt 210 may alternately be placed in a second transit position (not shown in FIG. 2) on the floor of the trailer 202, where the base belt 210 may be rolled or gathered during transit. From either the first or second transit position, to initiate unloading of the trailer 202, the second end of the base belt 210 is brought generally along the path indicated by the arrow 216 to be attached to the automatic unloader 200, as described in greater detail below.

The unloader 200 is positioned at the open door of the trailer 202 by an operator at an operator station 218. The operator may use a video camera (not shown in FIG. 2) that is mounted to the unloader 200 or to the loading dock 204 and presents the operator with a view of the unloader 200 and the trailer 202. The unloader includes a positioning mechanism 220, which is remotely operated by the operator to position the unloader 200 at the entrance to the trailer 202. The positioning mechanism 220 may be a motorized caster or other mechanism suitable for positioning the unloader 200 relative to the trailer 202 prior to initiating an unloading process or during the unloading process. The positioning mechanism 220 is operable to position the unloader 200 at least along a longitudinal axis of the trailer 202 or horizontally relative to the trailer 202. In some embodiments, the unloader 200 is substantially the same width as the interior of the trailer 202, such that the unloader 200 substantially fills the trailer 202 from one sidewall to the other sidewall.

The unloader 200 can also include a stack control curtain 222 mounted to a positioning mechanism 224. The unloader 200 is coupled to an extendible conveyor 226, which is operable to carry items unloaded by the unloader 200 from the trailer 202. A parcel sensor 250 may be mounted in a position that enables the parcel sensor 250 to sense items on the unloader 200 or the extendible conveyor 226. The parcel sensor 250 is operable to sense a label, RFID tag, barcode, or other identifying feature of such items, and may be implemented, for example, by one or more video cameras, barcode readers, or other devices.

FIG. 3 depicts an automated unloader system 300 according to the disclosure. Unloaders 302, 304, 306 and 308 according to the disclosure are controlled by a controller 310. Each of the unloaders 302-308 may be positioned at each of four truck docks and operated to unload four trailers separately or concurrently. An operator may use an operator station 312 to control the unloaders 302-308. The controller 310 may be communicatively coupled to a facility management system 314. The controller 310 may receive address or identification information sensed from items unloaded by one or more of the unloaders 302-308 and send the information to the facility management system 314 (or other external system) for its use in routing the items to desired destinations.

While the operator station 312, the controller 310, and the facility management system 314 are depicted in FIG. 3 as separate elements of the automated unloader system 300, it will be understood that in other embodiments, this functionality of these elements may be provided in one or two elements. In some embodiments, the automated unloader system 300 also includes one or more sensors (not shown in FIG. 3 but described in more detail below) providing a view of one or more of the unloaders 302-308 and one or more corresponding trailers or other containers. In such embodiments, the controller 310 is further adapted to control an unloader positioning mechanism to position the unloader in a desired position relative to the trailer, prior to initiating an unloading process.

The detailed structure and operation of some examples of automatic unloader systems in which disclosed systems and methods can be implemented are described in the patent documents incorporated by reference above and are not described in further detail here except when useful to describe the operations of the disclosed embodiments.

Disclosed embodiments improve the productivity of dealing with exceptions by allowing a single operator to resolve exceptions on many different unloaders, essentially allowing fractional staffing, and by reducing the number of exceptions.

An automatic unloader system as disclosed herein leverages includes a plurality of sensors and computerized controls and can collect operational data.

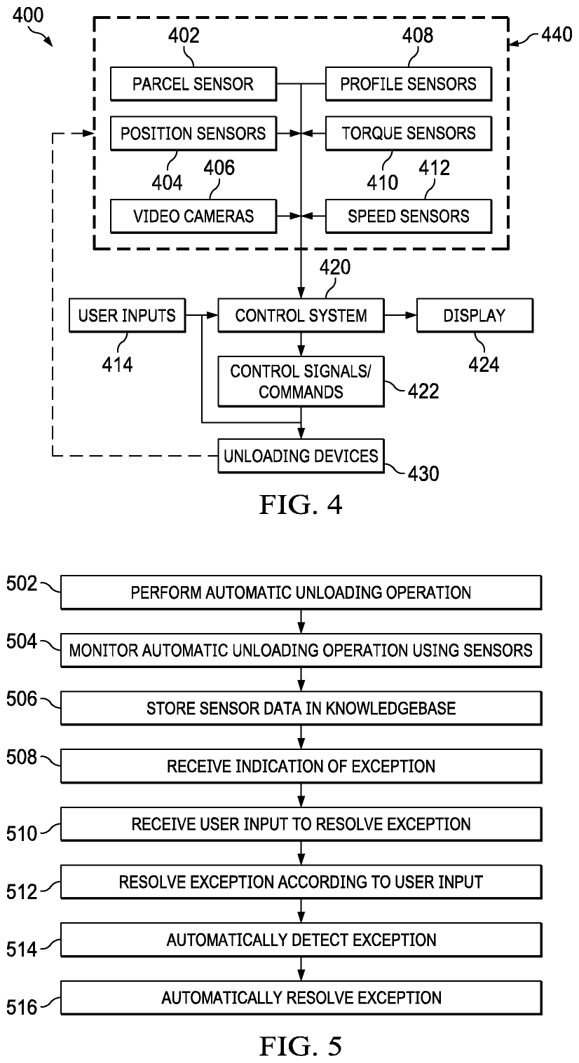

FIG. 4 illustrates some sensor and control elements of an automatic unloader system 400 in accordance with disclosed embodiments. The collected data can include the status of and information regarding the various sensors 440 that record the state of the environment in which the automatic unloader system is operating. These sensors 440, and related data. can include but are not limited to parcels sensors 402, position sensors 404, video cameras 406, profile sensors 408, torque sensors 410, and speed sensors 412. Note that there may be one or more of each of these sensors installed on a given conveyor system, and each automatic unloader system under the control of a common control system 420 may have its own set of some or all of these sensors.

Parcel sensors 402, as described above, can include cameras or barcode scanners configured to detect the presence of parcels on various stages of the automatic unloader system, and can be configured to read barcodes or other printed indicia on each parcel. Parcel sensors 402 can be configured to detect dimension, size, and weight information of each parcel.

Position sensors 404 can detect the position of each portion of the automatic unloader system, including any conveyors, belts, nose ramps, curtains, or other components, with respect to the base of the automatic unloader system or with respect to the container being unloaded.

Video cameras 406 can augment the parcel sensors 402 and position sensors 404, and in particular can be used to display a real-time view of the operation of the automatic unloader system to a user on the display 424 described below.

Profile sensors 408 are configured to determine the shape and volume of parcels in certain areas. Profile sensors 408 can map three dimensions of a target. Examples of profile sensors 408 can include LIDAR sensors, other Time-of-flight technologies, and others. Torque sensors 410 and speed sensors 412 are configured to measure the physical characteristics of the operation of the automatic unloader system, including the torque and speed of the belts and other conveyor portions, the speed that the automatic unloader system is moving into or out of the container, and other such physical data.

As illustrated in FIG. 4, each of the various sensors 440 is connected, directly or indirectly, to provide data or signals to control system 420. Control system 420 receives this data (including signals). Control system 420 also receives any user inputs 414, such as for manual activation, deactivation, steering, or other control of the elements of the automatic unloader system. Control system 424 can display this data, the user inputs, camera images, or any of the data or outputs it produces on display 424.

Control system 424 outputs control signals or commands (collectively, commands) 422 that are used to control or are executed by unloading devices 430, which can include any of the components of the automatic unloader system. These commands can be commands generated by the control system itself based on its own knowledgebase, previous programming, or configuration, and can be commands generated based on the user inputs 414. As the various unloading devices 430 execute the commands, these operations are also monitored by sensors 440, providing an effective feedback to control system 420 of the responses of unloading devices 430 to the control signals/commands 422 to enable machine learning.

Note that the commands 422 are also retained by control system 420 and used to supplement its knowledgebase. Control system 420 can save any of the data described above and any control operations or commands 422.

Control system 420 can use the data received from the various sensors to determine when an exception occurs and to identify the exception. In particular, when an exception is identified, control system 420 can add both the sensor data and the user inputs 414 to its knowledgebase to “learn” how the user resolves the exception and can apply this knowledge later to automatically resolve exceptions. When this data is accumulated for each exception across the many automatic unloader systems and processes, the control system can identify classes of exceptions within the data and associate corresponding resolutions with each of the classes of exceptions.

This information can be used in a machine learning system to identify inferences between the characteristics of exceptions as represented in the recorded data from sensors and other aspects of the machine and the actions recorded that resolved the exception. In this way, among all of the data regarding exception classes, critical data, or features of the class may be identified, the combinations of which correlating to the optimal pattern of manual control. When systematized, the data can be continuously screened for the confluence of features that will correlate to an exception, and either before or after an exception is identified, the system can duplicate the optimal recovery method automatically.

FIG. 5 illustrates a flowchart of a process in accordance with disclosed embodiments. The process of FIG. 5 can be implemented by using any of the features, components, or devices discussed herein, or any combination of them. The process of FIG. 5 is performed, for example, by an automatic unloader system as disclosed herein, and under the control of its control system.

The automatic unloader system performs an automatic unloading operation of parcels from a container (502). This can include performing automatic unloading operations of parcels from multiple different containers in cases where the automatic unloader system includes multiple unloaders controlled by the same control system.

The automatic unloader system monitors the automatic unloading operation using a plurality of sensors (504).

The automatic unloader system stores sensor data from the plurality of sensors in a knowledgebase (506). In this way, the automatic unloader system learns the typical and correct behavior and responses during the unloading operation, for example using machine-learning techniques.

The automatic unloader system receives an indication of an exception in the automatic unloading operation (508). This indication can be a user input from an operator, an error indication in one or more sensors, or other indication. The automatic unloader system can store the indication in the knowledgebase as associated with current or recent sensor data. In this way, the automatic unloader system learns the operating conditions that define a given exception type or class, for example using machine-learning techniques.

The automatic unloader system receives a user input to resolve the exception and stores the user input in the knowledgebase (510). As described herein, this can be any user input, series of actions, etc., by which the operator manually resolves the exception.

The automatic unloader system resolves the exception according to the user input (512). This can include the control system producing commands according to the user input to resolve the exception and storing these commands in the knowledgebase. This can include storing sensor data in the knowledgebase as associated with the resolution to the exception. In this way, the automatic unloader system learns the how to resolve an exception of a given type or class, for example using machine-learning techniques, and can store this as resolution knowledge.

Thereafter, the automatic unloader system continues to perform as in 502, 504, and 506.

The automatic unloader system automatically detects an exception based on current sensor data and the knowledgebase (514). This can include detecting the actual occurrence of the exception or detecting the impending occurrence of the exception. By applying the knowledge it has learned as stored in the knowledgebase, the automatic unloader system can detect or predict exceptions.

The automatic unloader system automatically resolves the exception using the knowledgebase (516). The automatic unloader system automatically resolves the exception using resolution knowledge generated from a previous manual resolution by an operator of a corresponding type of exception. By applying the knowledge it has learned as stored in the knowledgebase, the automatic unloader system can automatically resolve exceptions of the types or classes that it has learned.

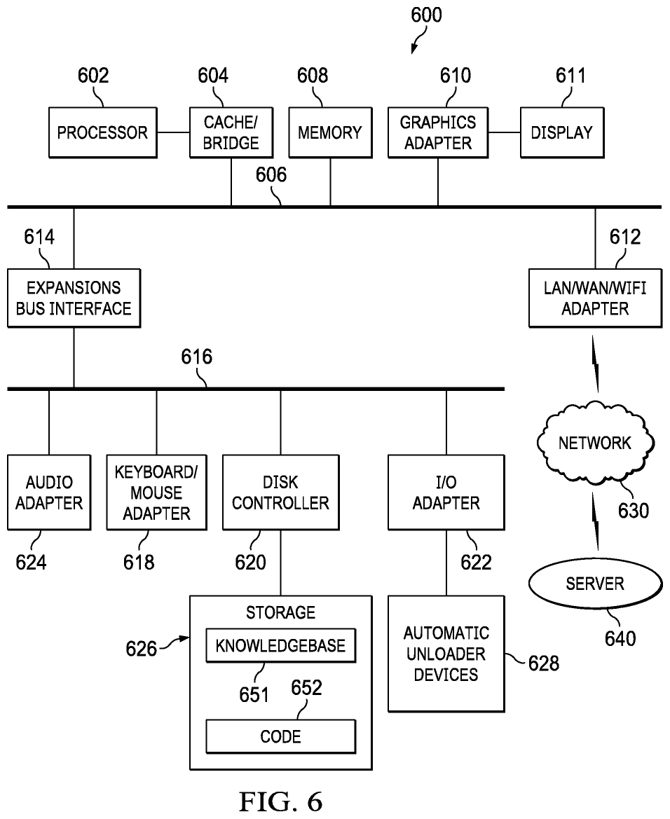

FIG. 6 depicts a block diagram of a data processing system 600 in which an embodiment can be implemented, for example as a control system for an automatic unloader system as described herein and can be configured to perform processes as described herein. The data processing system depicted includes a processor 602 connected to a level two cache/bridge 604, which is connected in turn to a local system bus 606. Local system bus 606 may be, for example, a peripheral component interconnect (PCI) architecture bus. Also connected to local system bus in the depicted example are a main memory 608 and a graphics adapter 610. The graphics adapter 610 may be connected to display 611.

Other peripherals, such as local area network (LAN)/Wide Area Network/Wireless (e.g. WiFi) adapter 612, may also be connected to local system bus 606. Expansion bus interface 614 connects local system bus 606 to input/output (I/O) bus 616. I/O bus 616 is connected to keyboard/mouse adapter 618, disk controller 620, and I/O adapter 622. Disk controller 620 can be connected to a storage 626, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Storage 626 can store any data and code useful for performing processes as described herein. For example, storage 626 can store knowledgebase 651, which can include any sensor data, control data, user inputs, device commands, exception indicators, exception recognition data, exception resolution data, resolution knowledge, or other data used for the monitoring and control of the automatic unloader system. Knowledgebase 651 can include, for example, a neural network or other data structures useful for machine learning processes. Storage 626 can also store, as another example, executable code 652 that, when executed, causes processes as described herein to be performed.

I/O adapter 622 can be connected to automatic unloader devices 628, as described herein, to which can include any hardware elements used to perform processes in accordance with the various embodiments described herein, including but not limited to sensors, conveyors, user input devices, display devices, etc.

Also connected to I/O bus 616 in the example shown is audio adapter 624, to which speakers (not shown) may be connected for playing sounds. Keyboard/mouse adapter 618 provides a connection for a pointing device (not shown), such as a mouse, trackball, trackpointer, etc.

Those of ordinary skill in the art will appreciate that the hardware depicted in FIG. 6 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™ a product of Microsoft Corporation located in Redmond, Wash. may be employed if suitably modified. The operating system is modified or created in accordance with the present disclosure as described.

LAN/WAN/Wireless adapter 612 can be connected to a network 630 (not a part of data processing system 600), which can be any public or private data processing system network or combination of networks, as known to those of skill in the art, including the Internet. LAN/WAN/Wireless adapter 612 can also communicate with other devices or systems as described herein or as known for use in parcel processing or monitoring, and perform other data processing system or server processes described herein. Data processing system 600 can communicate over network 630 with one or more server systems 640, which are also not part of data processing system 600, but can be implemented, for example, as separate data processing systems 600. A server system 640 can be, for example, a central server or facility management system at a processing facility.

The exemplary data processing system 600 can also be used to implement an operator console or facility management system as described herein.

Those skilled in the art will recognize that, for simplicity and clarity, the full structure and operation of all systems suitable for use with the present disclosure is not being depicted or described herein. Instead, only so much of the physical systems as is unique to the present disclosure or necessary for an understanding of the present disclosure is depicted and described. The remainder of the construction and operation of the systems disclosed herein may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs). In particular, computer readable mediums can include transitory and non-transitory mediums, unless otherwise limited in the claims appended hereto.

Although an exemplary embodiment of the present disclosure has been described in detail, those skilled in the art will understand that various changes, substitutions, variations, and improvements disclosed herein may be made without departing from the spirit and scope of the disclosure in its broadest form. In particular, the features and operations of various examples described herein and in the incorporated applications can be combined in any number of implementations.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle.

What is claimed is:

1. A method performed by an automatic unloader system, comprising:
performing an automatic unloading operation of parcels from a container;
monitoring the automatic unloading operation using a plurality of sensors;
automatically detecting an exception based on current sensor data and a knowledgebase storing past sensor data; and
automatically resolving the exception using the knowledgebase and using resolution knowledge generated from a previous manual resolution by an operator of a corresponding type of exception.

2. The method of claim 1, further comprising storing sensor data from the plurality of sensors in the knowledgebase.

3. The method of claim 1, further comprising, prior to the automatically detecting an exception:
receiving an indication of an exception in the automatic unloading operation;
receiving a user input to resolve the exception and storing the user input in the knowledgebase; and
resolving the exception according to the user input, including producing commands according to the user input to resolve the exception and storing the commands in the knowledgebase as the resolution knowledge.

4. The method of claim 1, wherein the plurality of sensors include one or more of a parcel sensor, a position sensor, a video camera, a profile sensor, a torque sensor, and a speed sensor.

5. The method of claim 1, wherein the knowledgebase includes a machine learning neural network.

6. The method of claim 1, wherein the knowledgebase stores sensor data, control data, user inputs, device commands, exception indicators, exception recognition data, and exception resolution data.

7. The method of claim 1, wherein the automatic unloader system predicts exceptions based on the sensor data and the knowledgebase.

8. The method of claim 1, wherein the automatic unloader system learns operating conditions that define an exception type.

9. The method of claim 1, wherein the automatic unloader system includes a plurality of automatic unloaders controlled by a same control system and a same operator station.

10. An automatic unloader system, comprising:
at least one automatic unloader; and
a control system, wherein the control system is configured to control the automatic unloader system to:
perform an automatic unloading operation of parcels from a container using the automatic unloader;
monitor the automatic unloading operation using a plurality of sensors;
automatically detect an exception based on current sensor data and a knowledgebase storing past sensor data; and
automatically resolve the exception using the knowledgebase and using resolution knowledge generated from a previous manual resolution by an operator of a corresponding type of exception.

11. The automatic unloader system of claim 10, wherein the control system is further configured to store sensor data from the plurality of sensors in the knowledgebase.

12. The automatic unloader system of claim 10, wherein the control system is further configured to, prior to the automatically detecting an exception:
receive an indication of an exception in the automatic unloading operation;
receive a user input to resolve the exception and storing the user input in the knowledgebase; and
resolve the exception according to the user input, including producing commands according to the user input to resolve the exception and storing the commands in the knowledgebase as the resolution knowledge.

13. The automatic unloader system of claim 10, wherein the plurality of sensors include one or more of a parcel sensor, a position sensor, a video camera, a profile sensor, a torque sensor, and a speed sensor.

14. The automatic unloader system of claim 10, wherein the knowledgebase includes a machine learning neural network.

15. The automatic unloader system of claim 10, wherein the knowledgebase stores sensor data, control data, user inputs, device commands, exception indicators, exception recognition data, and exception resolution data.

16. The automatic unloader system of claim 10, wherein the control system is further configured to predict exceptions based on the sensor data and the knowledgebase.

17. The automatic unloader system of claim 10, wherein the control system is further configured to learn operating conditions that define an exception type.

18. The automatic unloader system of claim 10, wherein the automatic unloader system includes a plurality of automatic unloaders controlled by the control system and a same operator station.
